(19) United States
(12) Patent Application Publication
(10) Pub. No.: US 2019/0390086 A1
(43) Pub. Date: Dec. 26, 2019

(54) A CURABLE COMPOSITION, A PRESSURE SENSITIVE ADHESIVE, AN ADHESIVE TAPE, AND AN ADHESIVE ARTICLE

(71) Applicant: 3M INNOVATIVE PROPERTIES COMPANY, St. Paul, MN (US)

(72) Inventor: Wenjie Zhang, Shanghai (CN)

(21) Appl. No.: 16/061,739

(22) PCT Filed: Dec. 15, 2015
(86) PCT No.: PCT/CN2015/097364

§ 371 Date: Feb. 25, 2019

(51) Int. Cl. C09J 7/38

(52) U.S. Cl. CPC C09J 7/387; C09J 2433/00; C09J 2453/00; C09J 2205/114

(57) ABSTRACT

The present invention provides a curable composition, a pressure sensitive adhesive, an adhesive tape, and an adhesive product, belonging to the technical field of pressure sensitive adhesives and can solve the problem of the poor drop protection performance of the existing pressure sensitive adhesives. The curable composition of the present invention comprises: monomer components, comprising at least two polymerizable monomers, wherein the polymerizable monomers comprise non-tertiary alcohol (meth)acrylate monomers, and acid-functional non-ester unsaturated monomers having at least one olefinic bond; at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

### TECHNICAL FIELD

The present invention belongs to the technical field of acrylate pressure sensitive adhesive, and more particularly, to a curable composition, a pressure sensitive adhesive, an adhesive tape, and an adhesive product.

### BACKGROUND

A pressure sensitive adhesive (PSA) is an adhesive sensitive to pressure, which forms a firm bonding to the adherend simply by applying a gentle force using a finger only, without needing other means such as a solvent or heat. The acrylate pressure sensitive adhesive is an important type among pressure sensitive adhesives and has features such as good weatherability, high performance-price ratio, good transparence, high cohesive strength, high bonding power, and a broad application range.

The acrylate pressure sensitive adhesive is frequently used in consumer electronic products. For example, in mobile terminals (cellphones), tablet computers, notebook computers, and the like, acrylate pressure sensitive adhesives, e.g., double sided acrylic foam adhesive tapes, can be used to stick a display panel to the casing.

With the popularity of narrow frames and frameless designs, double sided acrylic foam adhesive tapes in the above equipment have an increasingly narrower width. On the other hand, the size and weight of display panels are becoming larger, which in turn demands a higher drop protection performance of acrylate pressure sensitive adhesives. That is, when cellphones and the like are dropped accidentally, the display panel should not be separated from the casing due to the dropping impact.

However, the drop protection performance of existing acrylate pressure sensitive adhesives often cannot satisfy this requirement.

### SUMMARY

One objective of the present invention is to provide a curable composition which, after curing, forms a pressure sensitive adhesive having excellent drop protection performance.

The curable composition of the present invention comprises:

monomer components, comprising at least two polymerizable monomers, wherein the polymerizable monomers comprise non-tertiary alcohol (meth)acrylate monomers, and acid-functional non-ester unsaturated monomers having at least one olefinic bond; and
at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

Preferably, the above block copolymer is a tri-block copolymer of a block A-block B-block A structure.

Preferably, the block A is formed via polymerization of methyl methacrylate monomers; and the block B is formed via polymerization of alkyl acrylate monomers.

Preferably, the curable composition further comprises: a (meth)acrylate copolymer, formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond; and the (meth)acrylate copolymers have a weight average molecular weight of between 500000 Da and 10000000 Da.

More preferably, a slurry polymer is formed with the monomer component and the (meth)acrylate copolymer; and the slurry polymer is formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond.

Another objective of the present invention is to provide a pressure sensitive adhesive formed by curing the above curable composition so as to provide good drop protection performance.

Another objective of the present invention is to provide an adhesive tape comprising the above pressure sensitive adhesive so as to provide good drop protection performance.

A further objective of the present invention is to provide an adhesive product comprising the above pressure sensitive adhesive so as to provide good drop protection performance.

Preferably, the adhesive product is any one of a mobile terminal, a tablet computer, and a notebook computer. The casing of the above adhesive product is stick to the display panel using the above pressure sensitive adhesive.

### BRIEF DESCRIPTION OF THE DRAWINGS

FIG. 1 is a schematic view showing a testing method for the drop protection performance of embodiments of the present invention.

### DETAILED DESCRIPTION

In order to allow a person of skill in the art to better comprehend technical solutions of the present invention, the present invention is further described in detail below in combination with accompanying drawings and particular embodiments.

### Interpretation of Terms

In the present invention, the meanings of the following terms or descriptions are as follows:

The description of “A and/or B” means that any one or both of the two cases may occur, i.e., including “A and B”, “A”, and “B.”

The description of “A to B” or “between A and B” includes values of A and B, and any value greater than A and less than B. For example, “1 to 10” includes 1, 10, and any value greater than 1 and less than 10, e.g., 2, 3, 4, 5, 6, 7, 8, 9, 2.3, 3.5, 5.26, 7.18, and 9.999, etc.

The description of “A is essentially B” or “A is about B” denotes that A is, in general, in compliance with the B condition; but a certain difference possibly exists between A and B; and the difference is small on the scale of B.

Unless otherwise specified, “viscosity” referred to in the present invention is measured with an ubbelohde viscometer.

Unless otherwise specified, “molecular weight” referred to in the present invention is a weight average molecular weight and is measured using the gel permeation chromatography (GPC).

The “glass transition temperature (Tg)” refers to a temperature at which transformation between a high-elastomeric state and a vitreous state of a polymer takes place, namely a temperature at which an amorphous portion of the polymer is transformed from a frozen state to a thawed state. Unless otherwise specified, the glass transition temperatures referred to in the present invention are all determined by differential scanning calorimetry (DSC).

The “glass transition temperature of a monomer” refers to the glass transition temperature of a homopolymer of the corresponding monomer.

“Substance amount used,” unless otherwise specified, refers to weights or ratios by weight for the amounts or ratios of the substance amounts used herein.

“Percentage by weight of B in A” means that B is a part of A, and refers to the weight percentage of B with the weight of A (including B) being 100%.

“Percentage by weight of B based on the weight of A” means that B does not belong to A, and refers to the weight percentage of B based on the weight of A with the weight of A (not including B) being 100%.

An “elastomer” refers to a polymeric material that can still essentially restore to its original shape after being deformed to a great extent, or a material having a large elastic deformation range, such as a polymeric material that can still essentially restore to its original length after being stretched to twice the original length.

The description of “(meth)acrylic acid” refers to two situations, i.e., acrylic acid and methacrylic acid.

The description of “(meth)acrylate” refers to two situations, i.e., (meth)acrylate and methacrylate, i.e., a generic term of esters of (meth)acrylic acid and homologues thereof; and specific optional examples include methyl acrylate, ethyl acrylate, methyl methacrylate, ethyl methacrylate, and the like.

“Tertiary alcohol” refers to an alcohol in which the other three groups to which the carbon atom is attached where the hydroxyl group is located are all non-hydrogen substituents; and “non-tertiary alcohol” refers to an alcohol that does not belong to the tertiary alcohol.

A “polymer” refers to a substance formed from a polymerization reaction of one or more polymerizable monomers, including homopolymers, copolymers, trimers, and the like.

A “copolymer” refers to a polymer formed via polymerization of at least two different polymerizable monomers, i.e., all polymers other than homopolymers, including random copolymers, block copolymers, graft copolymers, alternating copolymers, and mixtures thereof, and the like.

A “block copolymer” is a polymer formed by linking together two or more different polymer segments, where each polymer segment is a continuous chain formed via polymerization of the same polymerizable monomers and is referred to a “block”; and as a result of the specific structure thereof, most of block copolymers are elastomers.

A “tri-block copolymer” means a block copolymer comprised of three blocks and further means a block copolymer formed of two blocks A and one block B.

“Partial copolymerization” means that a portion of polymerizable monomers as the raw material have been copolymerized to form copolymers; and at the same time, the other portion of the polymerizable monomers have not yet been copolymerized and are kept in the monomer form.

“Curing” means a process during which a liquid substance is transformed from a liquid state into a solid state with viscoelastic behaviors by means of polymerization and/or crosslinking of components therein.

A “pressure sensitive adhesive” means a substance that can be bonded to a substrate and at least meet the following conditions at the ambient temperature (5° C. to 40° C.): (1) the substance has a lasting stickiness; (2) bonding can be achieved under the pressure of finger press; (3) the substance changes its shape to be attached to the substrate; and (4) the substance has sufficient cohesive strength to be removed essentially clearly from the adherend.

An “adhesive tape” means a product having an essentially-strip shape which can be bonded to a substrate or can stick two substrates together.

### Curable Composition

The present invention provides a curable composition which can be cured to form a pressure sensitive adhesive with excellent drop protection performance, particularly by means of ultraviolet light.

The curable composition of the present invention comprises:

monomer components, comprising at least two polymerizable monomers, wherein the polymerizable monomers comprise non-tertiary alcohol (meth)acrylate monomers, and acid-functional non-ester unsaturated monomers having at least one olefinic bond; and
at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

The curable composition of the present invention comprises a (meth)acrylate monomer which is a main component for forming an acrylate pressure sensitive adhesive. The pressure sensitive adhesive formed with the curable composition according to the present invention belongs to the category of acrylate pressure sensitive adhesives.

Meanwhile, the curable composition further comprises a polyacrylate elastomer. The elastomer is a block copolymer having on both ends blocks A formed via polymerization of methacrylate monomers, and at least one block B formed via polymerization of acrylate monomers is provided in the middle.

The present inventors creatively discovered that the addition of the above acrylic elastomer (block copolymer) into the (meth)acrylate monomer can provide the pressure sensitive adhesive formed by curing the curable composition with good performance, and particularly with excellent drop protection performance.

Preferably, the curable composition further comprises: a (meth)acrylate copolymer, formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond; and the (meth)acrylate copolymers have a weight average molecular weight of between 500000 Da and 10000000 Da.

That is to say, the curable composition may further comprise a (meth)acrylate copolymer, which may be formed by copolymerization of the same type of raw material as the above monomer component; and the presence of the above copolymer facilitates the improvement of quality of the pressure sensitive adhesive formed of the curable composition; particularly, the presence of the above copolymer can adjust the viscosity of the curable composition. This is because if the content of the monomer component in the curable composition is too high, the viscosity becomes too low, which poses difficulty in the process of forming the pressure sensitive adhesive. Because the above monomer component actually also forms a (meth)acrylate copolymer after copolymerization, theoretically speaking, it is feasible that the curable composition contains no (meth)acrylate copolymer, and a pressure sensitive adhesive is formed directly via polymerization of the monomer component when cured.

More preferably, a slurry polymer is formed with the monomer component and the (meth)acrylate copolymer; and the slurry polymer is formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond.

In other words, a raw material comprising the above polymerizable monomer can be used to carry out partial copolymerization, thereby to form a mixture formed of the monomer and the copolymer, i.e., a slurry polymer. In the slurry polymer, some polymerizable monomers have been copolymerized to form a copolymer, i.e., the above (meth)acrylate copolymer; and at the same time, the other polymerizable monomers have not yet been copolymerized and are kept in the monomer form, i.e., the monomer component above. In the slurry polymer, the unpolymerized polymerizable monomers serve as a solvent to dissolve the solute copolymer to then form a homogeneous system.

The advantage of using a slurry polymer is that the same raw material can be used to obtain the appropriate monomer components and (meth)acrylate copolymers directly, without needing to prepare different monomer components and (meth)acrylate copolymers separately.

Apparently, when the monomer component and the (meth)acrylate copolymer are in the form of a slurry polymer, they are necessarily formed using the same raw material; however, this does not mean that the monomer component and the (meth)acrylate copolymer have the same actual ingredients, which is because that in the copolymerization process, different polymerizable monomers may have different copolymerization rates and orders. Further, if a monomer component and a (meth)acrylate copolymer are prepared separately to formulate a slurry polymer, using the same raw material for both is not required.

The effect, optional substance, content, and the like of each component will be introduced below.

For the sake of conciseness and convenience, the following monomer component and (meth)acrylate copolymer will be described in the form of a slurry polymer, which should not be understood as limiting the present invention, however.

### 1. Slurry Polymer

### 1) Properties of Slurry Polymer

The slurry polymer is a mixture formed via partial copolymerization of a raw material comprising at least two polymerizable monomers; and this mixture comprises unpolymerized polymerizable monomers (i.e., monomer components) and copolymers (i.e., (meth)acrylate copolymers) formed via copolymerization of the polymerizable monomer. Because the polymerizable monomer in the slurry polymer is only partially copolymerized, it is not crosslinked or only marginally crosslinked; and thus the copolymer therein still can be dissolved in the unpolymerized polymerizable monomer. Therefore, the slurry polymer is in general a liquid homogeneous system, which is fluid that facilitates operations such as coating.

Preferably, the (meth)acrylate copolymer in the slurry polymer has a weight average molecular weight of between 500000 Da (g/mol) and 10000000 Da, and more preferably between 750000 Da and 6000000 Da. Specifically, the copolymer that has been formed in the slurry polymer may have a weight average molecular weight of at least 500000 Da centipoise, or at least 750000 Da, or at least 1000000 Da; and the weight average molecular weight may at most be 10000000 Da, at most be 6000000 Da, or at most be 5000000 Da.

Preferably, at 22° C., the slurry polymer has a viscosity of between 500 centipoise (cPs) and 10000 centipoise, and more preferably between 500 centipoise and 7000 centipoise. Specifically, the slurry polymer may have a viscosity of at least 500 centipoise, or at least 1500 centipoise, or at least 2500 centipoise; and at most a viscosity of 10000 centipoise, at most of 7000 centipoise, or at most of 5500 centipoise.

Preferably, in the polymerizable monomer for forming a slurry polymer, a weight proportion of the polymerizable monomer that has been polymerized is between 1% and 30%. In other words, if the raw material of all polymerizable monomers for forming a slurry polymer is taken as 100 parts by weight, the amount of polymerizable monomers that have been polymerized to form copolymers is from 1 part by weight to 30 parts by weight; and polymerizable monomers that have not been polymerized are from 70 parts by weight to 99 parts by weight, or the monomer conversion is from 1% to 30%. Specifically, the above monomer conversion may be at least 1%, at least 2%, at least 5%, or at least 7%; and the monomer conversion may be at most 30%, at most 20%, at most 15%, or at most 12%.

Slurry polymers with the above viscosity, weight average molecular weight, and monomer conversion are relatively suitable for use in curable compositions.

### 2) Polymerizable Monomer for Forming Slurry Polymer

The above polymerizable monomers for forming slurry polymers include non-tertiary alcohol (meth)acrylate monomers, and acid-functional non-ester unsaturated monomers having at least one olefinic bond; and preferably may further include non-acid-functional ethylenically unsaturated polar monomers and/or vinyl monomers.

In other words, the slurry polymer is preferably formed via partial copolymerization of a raw material comprising the above polymerizable monomers. Therefore, monomer components of the curable composition would certainly include these polymerizable monomers; and the (meth)acrylate copolymer in the curable composition is also formed via copolymerization of these polymerizable monomers.

Each polymerizable monomer will be further introduced below.

### (1) Non-Tertiary Alcohol (Meth)acrylate Monomer

Preferably, the number of carbon atoms in the non-tertiary alcohol for forming the non-tertiary alcohol (meth)acrylate monomer is between 1 and 20, more preferably between 2 and 18, and further preferably between 4 and 12.

The segment of the non-tertiary alcohol for forming the above non-tertiary alcohol (meth)acrylate monomer may be linear, or alternatively be branched or a combination thereof. Specifically, the above non-tertiary alcohol includes, but is not limited to, any one or more of: methanol, ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, iso-octyl alcohol, 2-ethyl-1-hexanol, 1-decanol, 2-propylheptanol, 1-dodecanol, 1-tridecanol, and 1-tetradecanol. Although the above non-tertiary alcohols are all suitable, in some preferred embodiments, the non-tertiary alcohol is preferably any one or more of butanol, iso-octyl alcohol, 2-ethylhexanol (with corresponding esters being iso-octyl (meth)acrylate, 2-ethylhexyl (meth)acrylate, and butyl (meth)acrylate); and in other preferred embodiments, the non-tertiary alcohol is derived from an alcohol of renewable sources, such as any one or more of 2-octanol, citronellol, and dihydrocitronellol.

In polymerizable monomers for forming a slurry polymer (i.e., the monomer component, and the polymerizable monomer for forming the (meth)acrylate copolymer), the non-tertiary alcohol (meth)acrylate monomer has a weight percentage of between 50% and 99.5%.

That is, in every 100 parts by weight of the polymerizable monomer for forming the slurry polymer, the above non-tertiary alcohol (meth)acrylate monomer preferably accounts for 50 parts by weight to 99.5 parts by weight, and more preferably accounts for 95 parts by weight to 99.5 parts by weight. Specifically, the above non-tertiary alcohol (meth)acrylate monomer may be at least 50 parts by weight, at least 70 parts by weight, at least 90 parts by weight, or at least 95 parts by weight; and the above non-tertiary alcohol (meth)acrylate monomer may be at most 99.5 parts by weight, at most 98 parts by weight, at most 96 parts by weight, or at most 90 parts by weight.

In the above non-tertiary alcohol (meth)acrylate monomer, preferably a portion thereof has a high Tg (glass transition temperature), i.e., the homopolymer thereof has a Tg of at least 25° C., and preferably at least 50° C. High-Tg non-tertiary alcohol (meth)acrylate monomers include, but are not limited to, any one or more of methyl methacrylate, ethyl methacrylate, isopropyl methacrylate, n-butyl methacrylate, i-butyl methacrylate, s-butyl methacrylate, stearyl alcohol methacrylate, phenyl methacrylate, cyclohexyl methacrylate, isobornyl acrylate, isobornyl methacrylate, benzoyl methacrylate, 3,3,5-trimethylcyclohexyl acrylate, cyclohexyl acrylate, N-octyl acrylamide, and propyl methacrylate.

In every 100 parts by weight of the polymerizable monomer for forming the slurry polymer, the high-Tg non-tertiary alcohol (meth)acrylate monomer preferably accounts for 0 parts by weight to 25 parts by weight (0 represents that it may not be included), and more preferably accounts for 0 part by weight to 20 parts by weight. Specifically, none or at least 2 parts by weight of, or at least 5 parts by weight of the above high-Tg non-tertiary alcohol (meth)acrylate monomer may be included; and the high-Tg non-tertiary alcohol (meth)acrylate monomer may be at most 25 parts by weight, at most 20 parts by weight, or at most 15 parts by weight. The amount of the high-Tg non-tertiary alcohol (meth)acrylate monomer is included in the amount of all the non-tertiary alcohol (meth)acrylate monomers. For example, if the total amount of non-tertiary alcohol (meth)acrylate monomers is 90 parts by weight and the amount of high-Tg non-tertiary alcohol (meth)acrylate monomer is 10 parts by weight, it means that in the total of 90 parts by weight of non-tertiary alcohol (meth)acrylate monomers, 10 parts by weight thereof have a high Tg and the rest 80 parts by weight thereof are other non-tertiary alcohol (meth)acrylate monomers with a lower Tg.

### (2) Acid-Functional Non-Ester Unsaturated Monomer Having at Least One Olefinic Bond

The acid-functional non-ester unsaturated monomer having at least one olefinic bond comprises both an olefinic bond and an acid functional group, wherein the acid functional group may be acid like carboxylic acid, or a salt of acid, like an alkali metal salt of carboxylic acid; but it cannot an ester. The acid-functional non-ester unsaturated monomer having at least one olefinic bond may be ethylenically unsaturated carboxylic acid, ethylenically unsaturated sulfonic acid, ethylenically unsaturated phosphonic acid and the like; particularly, they include, but are not limited to any one or more of: acrylic acid, methacrylic acid, itaconic acid, fumaric acid, crotonic acid, citraconic acid, maleic acid, oleic acid, styrene sulfonic acid, 2-acrylamide-2-methyl propanesulfonic acid, and vinyl phosphonic acid. In consideration of easy implementation, the acid-functional non-ester unsaturated monomer having at least one olefinic bond is more preferably ethylenically unsaturated carboxylic acid, such as (meth)acrylic acid.

In polymerizable monomers for forming a slurry polymer (i.e., the monomer component, and the polymerizable monomer for forming the (meth)acrylate copolymer), the above acid-functional non-ester unsaturated monomer having at least one olefinic bond has a weight percentage of between 0.5% and 15%, and more preferably between 0.5% and 5%.

That is, in every 100 parts by weight of the polymerizable monomer for forming the slurry polymer, the above acid-functional non-ester unsaturated monomer having at least one olefinic bond preferably accounts for 0.5 part by weight to 15 parts by weight, and more preferably accounts for 0.5 part by weight to 5 parts by weight. Specifically, the above acid-functional non-ester unsaturated monomer having at least one olefinic bond may be at least 0.5 part by weight, at least 1 part by weight, or at least 2 parts by weight; and the acid-functional non-ester unsaturated monomer having at least one olefinic bond may be at most 15 parts by weight, at most 10 parts by weight, or at most 5 parts by weight.

### (3) Non-Acid Functional and Ethylenically Unsaturated Polar Monomer

Preferably, the polymerizable monomers for forming the slurry polymer may further include non-acid functional and ethylenically unsaturated polar monomers (which may include esters but are different from the non-tertiary alcohol (meth)acrylate monomer mentioned earlier). The available non-acid functional and ethylenically unsaturated polar monomers include, but are not limited to, any one or more of: 2-hydroxyethyl (meth)acrylate, N-vinylpyrrolidone, N-vinyl caprolactam, acrylamide, mono-N-alkyl-substituted acrylamide, di-N-alkyl-substituted acrylamide, t-butyl acrylamide, dimethylaminoethyl acrylamide, N-octyl acrylamide, and poly(alkoxyalkyl) (meth)acrylate, wherein poly(alkoxyalkyl) (meth)acrylate includes any one or more of 2-(2-ethoxyethoxy)ethyl (meth)acrylate, 2-ethoxyethyl (meth)acrylate, 2-methoxyethoxyethyl (meth)acrylate, 2-methoxyethyl methacrylate, and polyethylene glycol mono(meth)acrylate. Apparently, the non-acid functional and ethylenically unsaturated polar monomer described herein does not include the other monomers mentioned above; that is, it is different from the above non-tertiary alcohol (meth)acrylate monomer.

In polymerizable monomers for forming a slurry polymer (i.e., the monomer component, and the polymerizable monomer for forming the (meth)acrylate copolymer), the non-acid functional and ethylenically unsaturated polar monomer has a weight percentage of less than or equal to 45%.

That is, in every 100 parts by weight of the polymerizable monomer for forming the slurry polymer, the non-acid functional and ethylenically unsaturated polar monomer preferably accounts for 0 part by weight to 45 parts by weight (0 means that it may not be included). Specifically, none or at least 1 part by weight of, at least 2 parts by weight of, or at least 5 parts by weight of the non-acid functional and ethylenically unsaturated polar monomer may be included; and the non-acid functional and ethylenically unsaturated polar monomer may be at most 45 parts by weight, at most 40 parts by weight, or at most 35 parts by weight.

### (4) Vinyl Monomer

Preferably, the polymerizable monomer for forming the slurry polymer may further include a vinyl monomer, which is a monomer having vinyl content as an important part, including, but not limited to, any one or more of: vinyl esters (e.g., vinyl acetate and vinyl propionate), styrene, substituted styrene (e.g., α-methylstyrene), and vinyl halides. Apparently, the vinyl monomer described herein does not include the other monomers mentioned above; that is, it is different from the above non-tertiary alcohol (meth)acrylate monomers, acid-functional non-ester unsaturated monomers having at least one olefinic bond, non-acid functional, and ethylenically unsaturated polar monomers.

In polymerizable monomers for forming a slurry polymer (i.e., the monomer component, and the polymerizable monomer for forming the (meth)acrylate copolymer), the vinyl monomer has a weight percentage of less than or equal to 5%.

That is, in every 100 parts by weight of the polymerizable monomer for forming the slurry polymer, the vinyl monomer preferably accounts for 0 part by weight to 5 parts by weight (0 represents that it may not be included). Specifically, none or at least 0.1 part by weight of, or at least 0.5 part by weight of the vinyl monomer may be included; and the vinyl monomer may be at most 5 parts by weight, at most 4 parts by weight, or at most 3 parts by weight.

The above non-acid functional and ethylenically unsaturated polar monomer and vinyl monomer are optional components. That is, they may not be included in the polymerizable monomers for forming the slurry polymer; yet, it is a known technique to optionally include these components to improve the performance of the slurry polymers.

### 2. Block Copolymer

The curable composition of the present invention further comprises one or more block copolymers, which are elastomers.

The block copolymer of the present invention comprises at least two blocks A located respectively on both ends and at least one block B located in the middle, wherein the block A is formed via polymerization of methacrylate monomers, and the block B is formed via polymerization of acrylate monomers.

In other words, both ends of the block copolymer of the present invention must be blocks A formed via polymerization of methacrylate monomers; and a block B formed via polymerization of acrylate monomers is provided in the middle. In general, the above block A has a hardness higher than the block B, favoring improvement in the elasticity of the elastomer.

Preferably, the above block A is formed via polymerization of alkyl methacrylate monomers; the number of carbon atoms in alkyl therein is between 1 and 6, between 1 and 4, or between 1 and 3. The above block B, on the other hand, is formed via polymerization of alkyl acrylate monomers; the number of carbon atoms in alkyl therein is between 3 and 20, between 4 and 20, between 4 and 10, or between 4 and 6. When the above number of carbon atoms is within a certain range, each block can certainly be formed of different specific monomers.

Preferably, the number of carbon atoms in alkyl of the alkyl methacrylate monomer for forming the block A is less than that in alkyl of the alkyl acrylate monomer for forming the block B. For example, as the most preferred solution, the block A is formed via polymerization of methyl methacrylate monomers, and the block B is formed via polymerization of n-butyl acrylate monomers, i.e., the block A being poly(methyl methacrylate) and the block B being poly(n-butyl acrylate).

More preferably, the above block copolymer is a tri-block copolymer of a block A-block B-block A structure. That is, this block copolymer is preferably and exclusively formed of two blocks A located respectively on both ends and one block B located in the middle, and does not include other structures, thereby forming a simple ABA structure. For example, as the most preferred solution, the block copolymer is a tri-block copolymer of poly(methyl methacrylate)-poly(n-butyl acrylate)-poly(methyl methacrylate).

It certainly is also feasible that the block copolymer comprises other blocks or comprises alternately-arranged (AB) blocks in the middle. Specifically, the above block copolymers (elastomers) may be elastomer products such as LA1114, LA2140, LA2250, and LA2330 produced by Kuraray Co. Ltd., Tokyo, Japan.

Preferably, the above block copolymer has a weight average molecular weight of between 2000 Da and 500000 Da.

In other words, the above block copolymer has a weight average molecular weight of at least 2000 Da, at least 3000 Da, at least 5000 Da, at least 10000 Da, at least 40000 Da, or at least 60000 Da; and a weight average molecular weight of no more than 500000 Da, no more than 300000 Da, no more than 200000 Da, no more than 120000 Da, or no more than 80000 Da.

Preferably, in the above block copolymer, the block A has a weight percentage content of between 5% and 50%, and preferably between 20% and 30%; and the block B has a weight percentage content of between 50% and 95%, and preferably between 70% and 80%.

That is, in the block copolymer, the proportion of block A should be low, and its percentage by weight should be at least 5%, at least 7%, at least 10%, at least 20%, or at least 23%; and the percentage by weight of block A should be at most no more than 50%, no more than 40%, no more than 35%, or no more than 30%. Accordingly, in the block copolymer, the proportion of block B should be high, and its percentage by weight should be at least 50%, at least 55%, at least 60%, at least 65%, or at least 70%; and the percentage by weight of block B should be at most no more than 95%, no more than 90%, no more than 85%, no more than 80%, or no more than 75%.

### 3. Photoinitiator

Preferably, the curable composition of the present invention is photoinitiated; and thus it may contain a photoinitiator. A photoinitiator is used to produce free radicals under UV-irradiation, thereby initiating polymerization reaction. During the photoinitiation process, no additional organic solvents, i.e., solvents other than the polymerizable monomers, are used, so that the whole production process substantially is wastewater or exhaust gas pollution free and has high efficiency. Moreover, polymerization is initiated with ultraviolet light in the photoinitiation, which means that on the one hand, no heating is needed and the process is simple and feasible, low in power consumption and high in efficiency; and on the other hand, when the UV light source is turned off and the air is charged therein, the reactions can be terminated immediately. Thus the viscosity, monomer conversion, weight average molecular weight and the like of the product thereof can be controlled accurately.

Specific available photoinitiators include, but are not limited to, any one or more of: benzoin ether, such as benzoin methyl ether and benzoin isopropyl ether; substituted hypnone, such as 2,2-dimethoxyacetophenone; dimethoxyhydroxyhypnone; substituted α-ketol, such as 2-methyl-2-hydroxypropiophenone; aromatic sulfonyl chloride, such as 2-naphthalene-sulfonyl chloride; photosensitive oxime, such as 1-phenyl-1,2-propanedione-2-(O-ethoxy-carbonyl)oxime; 1-hydroxycyclohexylphenyl ketone; 1-[4-(2-hydroxyethoxy)phenyl]-2-hydroxy-2-methyl-1-propan-1-one; (4-methylthiobenzoyl)-1-methyl-1-morpholinyl ethane; (4-morpholinyl benzoyl)-1-benzyl-1-dimethylaminopropane; (4-morpholinylbenzoyl)-1-(4-methylbenzyl)-1-dimethylaminopropane; di(2,4,6-trimethylbenzene formyl)phenyl phosphine oxide; and 1-hydroxycyclohexylbenzophenone. Of these, a particularly preferred photoinitiator is substituted acetophenone.

Preferably, in the curable composition, based on every 100 parts by weight of the polymerizable monomer for forming the slurry polymer, the amount of the photoinitiator accounts for 0.001 part by weight to 3 parts by weight. Specifically, the photoinitiator may be used in an amount of at least 0.001 part by weight, at least 0.005 part by weight, or at least 0.01 part by weight; and at most 3 parts by weight, at most 1 part by weight, or at most 0.5 part by weight.

It is to be noted that the amount of the photoinitiators used herein refers to the total amount of the photoinitiator added into the curable composition. A portion (a typical weight percentage content based on the total amount is 10% to 20%) of these photoinitiators may be first added into the raw material of the slurry polymer for enabling partial polymerization reaction so as to obtain the slurry polymer; and then the rest portion is added into the slurry polymer obtained from the reaction to make the curable composition to be finally polymerized into a pressure sensitive adhesive.

### 4. Crosslinker

Preferably, the curable composition of the present invention may further comprise a crosslinker, and the addition of the crosslinker can improve the cohesive strength of the formed pressure sensitive adhesives. Available crosslinkers to be used in the present invention may include photosensitive crosslinkers, which can be activated through UV-irradiation. Common photosensitive crosslinkers include, but are not limited to, benzophenone; copolymerizable aromatic ketone; triazines, such as 2,4-bis(trichloromethyl)-6-(4-metoxybenzene)-triazine. Another available crosslinker is multi-functional (meth)acrylate, such as di(meth)acrylate, tri(meth)acrylate, and tetra(meth)acrylate; and particular examples include, but are not limited to, any one or more of: 1,6-hexanediol di(meth)acrylate, poly(ethylene glycol)di(meth)acrylate, polybutadiene di(meth)acrylate, polyurethane di(meth)acrylate, and propoxylated glycerol tri(meth)acrylate; and the multi-functional (meth)acrylate crosslinker is a non-photosensitive crosslinker but can improve the cohesive strength of the acrylate pressure sensitive adhesive (see U.S. Pat. No. 4,379,201). Another available crosslinker is a thermal-activation type of crosslinker, such as multifunctional aziridine, isocyanate and epoxy resin; and it may specifically be 1,1′-(1,3-phenylenedicarbonyl)-bis-(2-methyl aziridine). Among them, the most preferred crosslinker in the present invention is multi-functional (meth)acrylate.

Preferably, in the curable composition, based on every 100 parts by weight a polymerizable monomer for forming a slurry polymer, the amount of the crosslinker accounts for less than or equal to 5 parts by weight; that is, none or at least 0.01 part by weight, at least 0.03 part by weight of the crosslinker may be included; and the crosslinker may be used in an amount of at most 5 parts by weight, at most 2 parts by weight, or at most 1 part by weight.

### 5. Black Pigment

Because the pressure sensitive adhesive of the present invention is mainly used in bonding display panels of cellphones, tablet computers, and the like to the casing, it is desired that the adhesive preferably has a black appearance, so as to achieve shading and avoid being observed easily. To this end, a black pigment may be added into the curable composition, and the available black pigments include 9B117 (Penn Color Corporation, Pennsylvania State, U.S.A.).

In the curable composition, based on every 100 parts by weight a polymerizable monomer for forming a slurry polymer, the amount of the black pigment preferably accounts for less than or equal to 10 parts by weight; that is, none or at least 0.5 part by weight or at least 1 part by weight of the black pigment may be included; and the black pigment may be used in an amount of at most 10 parts by weight, at most 8 parts by weight, or at most 7 parts by weight.

### 6. Expanded Polymer Microsphere

In order to further improve the drop protection performance of the pressure sensitive adhesive, the adhesive should preferably have a property that functions like “foam.” Therefore, expanded polymer microspheres may be added into the curable composition. An expanded polymer microsphere is an essentially spherical known material comprised of a polymer casing and a cavity within the casing and is obtained by heating polymer particles enwrapping a vaporizable material; that is, the polymer casing is expanded via vaporization of the vaporizable material. The expanded polymer microsphere has a particle diameter preferably between 10 μm and 100 μm, and more preferably between 20 μm and 90 μm. Specific available expanded polymer microspheres can be found in Chinese Patent CN103320037B and the like and will not be described herein in detail.

In the curable composition, based on every 100 parts by weight a polymerizable monomer for forming a slurry polymer, the amount of the expanded polymer microsphere preferably accounts for less than or equal to 10 parts by weight; that is, none or at least 0.1 part by weight, or at least 0.5 part by weight of the expanded polymer microsphere may be included; and the expanded polymer microsphere may be used in an amount of at most 10 parts by weight, at most 9 parts by weight, or at most 8 parts by weight.

### 7. Tackifying Resin

In order to improve the bonding performance of a pressure sensitive adhesive, a tackifying resin can also be added into the curable composition. The tackifying resin may be used alone or in combination with other resins. Available tackifying resins include, but are not limited to, hydrogenated rosin resin FORAL 85LB (Pinova Corporation, Georgia State, U.S.A.), hydrogenated terpene phenolic resin UH115 (Yasuhara Chemical Corp., Hiroshima City, Japan), hydrocarbon resin-type tackifying resin REGRELTZ 6108 (Eastman Chemical Corporation, Tennessee State, U.S.A.), and acrylate polymer tackifying resins in U.S. Patent US20150044457 and Chinese Patent CN2014074139, etc.

In the curable composition, the tackifying resin is used under the premise that other performance of the curable composition is not affected. Specifically, based on every 100 parts by weight of a polymerizable monomer for forming a slurry polymer, the tackifying resin preferably accounts for no more than 35 parts by weight, no more than 25 parts by weight, no more than 10 parts by weight, or no more than 2 parts by weight; and the content of the tackifying resin may be preferably not lower than 0.1 part by weight, not lower than 1 part by weight, or not lower than 2 parts by weight.

### 8. Other Additives (e.g., Plasticizers, Antioxidants, Dispensing Agents, and Anti-Setting Agents) and Functional Components

Preferably, in order to improve different performance of product adhesive tapes, other various known additives may be added into the curable composition; and optional additives include, but are not limited to, any one or more of: plasticizers, antioxidants, dispensing agents, and anti-setting agents.

In addition, preferably, in order to provide the product of adhesive tapes with specific needed functions, functional components may be further added into the curable composition. For example, in order to improve the mold cutting performance of the products, short fibers and the like may be added therein.

It should be understood that the above various optional components should be added under the premise that the intrinsic performance (especially the drop protection performance) of the pressure sensitive adhesive is not affected.

At the same time, those skilled in the art may further add other known components into the curable composition if needed, which will not be described herein in detail.

### Preparation Method of Curable Composition

The above curable composition can be obtained by uniformly mixing various raw materials.

Preparation processes of a portion of the main raw materials of the curable composition will be described below.

### 1. Preparation Method of Slurry Polymer

When a slurry polymer is used as a raw material of a curable composition, the preparation method of the slurry polymer mainly includes two methods: one is UV initiated mass polymerization, referred to as UV initiation method; and the other is heat initiated solution polymerization, referred to as solution method. The two methods will be introduced below in detail.

### 1) UV Initiation Method

In the UV initiation method, no additional solvent is used; instead, raw materials of polymerizable monomers are directly mixed and partially copolymerized (mass polymerization); and the unpolymerized polymerizable monomer therein is used as a solvent to dissolve the copolymer formed in the polymerization, so as to obtain a slurry polymer. The process of the UV initiation method particularly includes:

### (1) Preparation of Raw Material

This step is to mix various polymerizable monomers for forming the slurry polymer.

If the polymerizable monomers contain the above high-Tg non-tertiary alcohol (meth)acrylate monomers, they may be added in this step in one batch (each embodiment of the present invention employs this method), or alternatively only a portion or none of the polymerizable monomers is added. The portion that is not added should be added directly into the slurry polymer that has finished the partial copolymerization, i.e., the curable composition. The reason to do so is that the polymerization of the high-Tg non-tertiary alcohol (meth)acrylate monomer is usually slow; and the addition at this time will not promote polymerization in a great amount.

Therefore, for the finally produced slurry polymer product, contents of the high-Tg non-tertiary alcohol (meth)acrylate monomer in polymerized and unpolymerized portions are different. In other words, in the curable composition, specific ingredients (including contents) of the polymerizable monomer raw materials that correspond to the monomer component and the (meth)acrylate copolymer may be different.

In this step, it also needs to mix all or some of the photoinitiators in the curable composition with the above polymerizable monomer, so as to initiate the polymerization reaction using UV initiation. Generally, the photoinitiator added in this step is part of the photoinitiator of the curable composition, in a weight percentage content of 10% to 20% based on the total amount.

### (2) UV-Irradiation of the Above Raw Materials, so as to Enable Partial Copolymerization of the Polymerizable Monomers to Obtain the Slurry Polymer

The available UV sources are generally divided into two categories: 1. low-intensity UV sources, such as black light, with a wavelength from 280 nm to 400 nm, and an intensity generally of 10 milliwatt/square centimeter (mw/cm²) or less; and 2. high-intensity UV sources such as medium pressure mercury lamps, with an intensity generally greater than 10 milliwatt/square centimeter, and more preferably between 15 milliwatt/square centimeter and 450 milliwatt/square centimeter. The UV intensity is measured using the UVIMAP™ UM 365 L-S radiometer (General Electronic Instrument Technology Co. Ltd., Virginia State, U.S.A.) by following the rules of the United States National Institute of Standards and Technology (NIST). In the present invention, preferably a low-intensity UV source with a UV intensity from 0.1 milliwatt/square centimeter to 150 milliwatt/square centimeter is used; particularly, the above UV intensity is at least 0.1 milliwatt/square centimeter, at least 0.5 milliwatt/square centimeter, or at least 1.5 milliwatt/square centimeter; and the UV intensity is at most 150 milliwatt/square centimeter, at most 100 milliwatt/square centimeter, or at most 50 milliwatt/square centimeter. The UV-irradiation time can be adjusted according to the light intensity and the polymerization situation, which is approximately several minutes in general. Alternatively, UV-light with high intensity and short irradiation time may be used, such as using 600 milliwatt/square centimeter for 1 sec.

In the polymerization process, the slurry polymer is continuously measured for the viscosity with a ubbelohde viscometer and the refractive index to judge the monomer conversion therein. After the predetermined standards are met, the UV-light is removed and air or oxygen is introduced into the slurry polymer to quench the free radicals and terminate the polymerization.

In the preparation process of the UV initiation method, no additional organic solvents, i.e., solvents other than the polymerizable monomers, are used, so that the whole production process substantially is wastewater or exhaust gas pollution free, environmentally friendly and has high efficiency. Also, polymerization is initiated with ultraviolet light in the photoinitiation, which means that on the one hand, no heating is needed and the process is simple and feasible, low in power consumption and high in efficiency; and on the other hand, when the UV light source is turned off and the gas is charged therein, the reactions can be terminated immediately. Thus the viscosity, monomer conversion, weight average molecular weight and the like of the product thereof can be controlled accurately.

Therefore, the UV initiation method is a preferred method for preparing a slurry polymer in this invention. In various embodiments of the present invention, slurry polymers are all prepared using this method.

### 2) Solution Method

The above slurry polymer may also be prepared using the solution method, wherein the polymerizable monomer can be dissolved in an additional organic solvent and polymerized; the additional organic solvent is then removed after the polymerization; and the remained substance is the slurry polymer. Particular steps of the solution method may include:

### (1) Preparation of Raw Material

Various polymerizable monomers for forming the slurry polymer, the thermal initiator and the like are dissolved in a solvent and nitrogen is charged therein for sufficient purification.

The available solvents include, but are not limited to, any one or more of: methanol, tetrahydrofuran, ethanol, isopropanol, acetone, butanone, methyl acetate, ethyl acetate, toluene, xylene, and ethylene glycol alkyl ether.

Thermal initiators are organic peroxide, organic hydroperoxide, azo compounds and the like that can generate free radicals. Available organic peroxides include, but are not limited to, any one or more of: benzoyl peroxide, lauroyl peroxide, di-tert-amyl peroxide, t-butyl peroxybenzoate, 2,5-dimethyl-2,5-di-(t-butylperoxy)hexane, 2,5-dimethyl-2,5-(t-butylperoxy)hexyne-3, and di-cumyl peroxide. Available organohydrogen peroxides include, but are not limited to, tert-cyclopentadienyl hydroperoxide and/or tert-butyl hydroperoxide. Available azo compounds include, but are not limited to any one or more of: 2,2′-azobis(isobutyronitrile), 2,2′-azobis(2-methylbutyronitrile), and 2,2′-azobis(2,4-dimethylvaleronitrile).

Based on every 100 parts by weight of the polymerizable monomer for forming the slurry polymer, the thermal initiator is added in an amount of preferably 0.05 to about 1 part by weight, and preferably about 0.1 to about 0.5 part by weight.

### (2) Heating the Solution to Partially Copolymerize the Polymerizable Monomers

The heating temperature is generally in a range of from 40° C. to 100° C.; and the heating time is generally in a range of from 1 h to 20 h. Specific selections depend on the total amount of the substances used, needed monomer conversion and the like.

### (3) Perform Vacuum Distillation to Remove the Additional Solvent to Obtain the Slurry Polymer

The particular vacuum distillation temperature can be determined according to the type of the additional solvent; and the vacuum distillation time tis determined under the premise that the additional solvent is essentially removed.

It is to be noted that although it is also feasible to prepare a slurry polymer using the solution method, the solution method is not the most ideal method, the reasons being that this method needs an additional solvent and the additional solvent removal step. This method therefore is high in cost and complex in process; additionally, this method requires heating and thus is high in power consumption. Moreover, monomers are usually polymerized slower in a solution and thus requires a long polymerization time (generally the polymerization time is several hours; the UV initiation method only takes several minutes) and the efficiency is low.

After the slurry polymer is obtained, the product of curable composition can be obtained only by adding therein and completely dissolving the other components (block copolymers, photoinitiators, crosslinkers and the like) of the curable composition. Preferably, generally components such as black pigments, photoinitiators, crosslinkers, and tackifying resins may be added first; and after they are completely dissolved, block copolymers (elastomers) are added; and if there are expanded polymer microspheres, they are then added therein the last; and such an addition sequence would guarantee a uniform distribution of various components. In each embodiment of the present invention, mixing is performed according to the above sequence.

### Pressure Sensitive Adhesive

The present invention further provides a pressure sensitive adhesive, obtained by curing the above curable composition.

That is, the above curable composition can be essentially and completely cured by means of UV-irradiation to form a pressure sensitive adhesive having excellent drop protection performance. The UV-irradiation time can be determined under the premise that the curable composition is essentially completely cured, which generally takes roughly several minutes.

### Adhesive Tape

The present invention further provides an adhesive tape, comprising the above pressure sensitive adhesive.

That is to say, the above pressure sensitive adhesive can be formed as an adhesive tape for the convenience of application.

Specifically, the adhesive tape of the present invention may comprise a backing and the above pressure sensitive adhesive is provided on the backing. When a backing is present, the above curable composition can be coated on the backing and then cured by UV-irradiation to obtain an adhesive tape comprising the backing and the above pressure sensitive adhesive. Alternatively, the curable composition may also be coated on a temporary separable substrate (e.g., a release film) and cured with UV-irradiation to form an adhesive film; and then the adhesive film of the pressure sensitive adhesive is transferred onto other backing.

The above method for coating a curable composition includes, but is not limited to, roller coating, flow coating, dip coating, spin coating, spray coating, blade coating, mold coating and the like, which are not described herein in detail; and the dry adhesive (i.e., the pressure sensitive adhesive) formed after the coating has a thickness generally from 50 μm to 500 μm, more preferably at least 100 μm, or at least 200 μm; and preferably at most 400 μm, or at most 300 μm.

The backing is preferably flexible and may include plastics, such as polyolefins, such as polyethylene, polypropylene (including isotactic polypropylene), polystyrene, polyester, polyvinyl alcohol, poly(ethylene terephthalate), poly(butylene terephtalate), poly(caprolactam), poly(vinylidene fluoride), polylactide, cellulose acetate, and ethyl cellulose. Moreover, a surface of the backing may further have a specific micro-replication structure to improve the performance of the adhesive tape, and the micro-replication structure may be as those described in U.S. Pat. Nos. 5,141,790, 5,296,277, and 5,362,516, etc. Alternatively, the backing may be fabrics, such as cotton, nylon, rayon, glass threads, and ceramic wires, etc. Alternatively, the backing may also be nonwoven fabrics, such as nonwoven fabrics obtained from natural fiber and/or synthetic fiber through air laying.

In an adhesive tape with a backing, the backing may have the above pressure sensitive adhesive only on one side thereof and have no adhesive or have other adhesive on the other side; or the backing may have the above pressure sensitive adhesive on both sides thereof; and the adhesive tape thus becomes a double-faced adhesive tape.

Also, on the backing, there may be only the pressure sensitive adhesive of the present invention, or there may be other additional known adhesive at the same time. Specifically, the pressure sensitive adhesive of the present invention may directly contact the backing and further have other known adhesive on the outer side of the pressure sensitive adhesive (i.e., the pressure sensitive adhesive of the present invention plays a role as a medium); alternatively, other known pressure sensitive adhesive may directly contact the backing and have the adhesive of the present invention on the outer side thereof (i.e., the pressure sensitive adhesive of the present invention directly acts as an bonding agent).

Alternatively, as a further embodiment of the present invention, the backing may also be formed with the pressure sensitive adhesive of the present invention; and preferably, on one or both sides of the backing, other known adhesive may be further provided. In other words, the pressure sensitive adhesive of the present invention (especially the pressure sensitive adhesive having foam properties) may also serve as the backing; and the backing may be present by itself, thereby forming an “adhesive film” with adhesiveness on both sides. Alternatively, the backing may also be used together with other adhesives; that is, other known adhesives may be provided on one or both sides thereof.

In summary, the pressure sensitive adhesive of the present invention may serve as a separate adhesive film (backing or foam), or may serve as a backing of an adhesive tape bearing other adhesive, or may serve as an adhesive attached on other backings.

For ease of using the adhesive tape, a release film or release paper may be further provided therein to avoid unexpected bonding when it is not in use. Specifically, the forms of the release film or release paper are numerous and well known, such as organosilicon coated kraft paper, glassine paper, cast kraft paper, and poly(ethylene terephthalate). When the adhesive film formed with the pressure sensitive adhesive directly contacts the release film or release paper, the pressure sensitive adhesive may alternatively be directly formed on the release film or release paper.

### Adhesive Product

The present invention further provides an adhesive product, comprising a first member, wherein at least a partial surface of the first member has the above pressure sensitive adhesive bonded thereon.

That is, the present invention provides an adhesive product, comprising the above pressure sensitive adhesive. The adhesive product is then enabled to bond with other products through the above pressure sensitive adhesive, or a plurality of members in the adhesive product are enabled to bond together through the above pressure sensitive adhesive.

Preferably, the above adhesive product further comprises a second member bonded together with the first member through the above pressure sensitive adhesive.

In short, a plurality of members in the adhesive product can be bonded together through the above pressure sensitive adhesive. As noted above, the pressure sensitive adhesive of the present invention may serve as a separate adhesive film (backing or foam), or may serve as a backing of an adhesive tape bearing other adhesive, or may serve as an adhesive attached on other backings.

Preferably, the above adhesive product is any one of a mobile terminal, a tablet computer, and a notebook computer; the first member is a casing; and the second member is a display panel.

That is, the pressure sensitive adhesive of the present invention is preferably used for bonding display panels of mobile terminals (cellphones), tablet computers, notebook computers and the like, to the casings. This is because these products tend to be dropped accidentally, and thus the drop protection performance of the pressure sensitive adhesive therein is relatively important.

The description above should not be construed as limiting the specific form of the adhesive product. Any products that include the above pressure sensitive adhesive are all adhesive products.

### Particular Embodiments of the Present Invention

An embodiment of the present invention provides a curable composition, comprising:

monomer components, comprising at least two polymerizable monomers, wherein the polymerizable monomers comprise non-tertiary alcohol (meth)acrylate monomers, and acid-functional non-ester unsaturated monomers having at least one olefinic bond; and
at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

Preferably, the block copolymer is a tri-block copolymer of a block A-block B-block A structure.

Preferably, the block A is formed via polymerization of alkyl methacrylate monomers; and the block B is formed via polymerization of alkyl acrylate monomers.

Preferably, the number of carbon atoms in alkyl of the alkyl methacrylate monomer is between 1 and 6; the number of carbon atoms in alkyl of the alkyl acrylate monomer is between 3 and 20; and the number of carbon atoms in alkyl of the alkyl methacrylate monomer is less than that in alkyl of the alkyl acrylate monomer.

Further preferably, the alkyl methacrylate monomer is a methyl methacrylate monomer; and the alkyl acrylate monomer is a n-butyl acrylate monomer.

Preferably, the block copolymer has a weight average molecular weight of between 2000 Da and 500000 Da.

Further preferably, the block copolymer has a weight average molecular weight of between 40000 Da and 120000 Da.

Preferably, in the block copolymer, the block A has a weight percentage content of between 5% and 50%; and the block B has a weight percentage content of between 50% and 95%.

Further preferably, in the block copolymer, the block A has a weight percentage content of between 20% and 30%; and the block B has a weight percentage content of between 70% and 80%.

Preferably, the curable composition further comprises: a (meth)acrylate copolymer, formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond; and the (meth)acrylate copolymers have a weight average molecular weight of between 500000 Da and 10000000 Da.

Further preferably, a slurry polymer is formed with the monomer component and the (meth)acrylate copolymer; and the slurry polymer is formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond.

Further preferably, in the polymerizable monomer for forming the slurry polymer, the non-tertiary alcohol (meth)acrylate monomer has a weight percentage content of between 50% and 99.5%; and the acid-functional non-ester unsaturated monomers having at least one olefinic bond has a weight percentage content of between 0.5% and 15%.

Further preferably, in the polymerizable monomer for forming the slurry polymer, the non-tertiary alcohol (meth)acrylate monomer has a weight percentage content of between 95% and 99.5%; and the acid-functional non-ester unsaturated monomers having at least one olefinic bond has a weight percentage content of between 0.5% and 5%.

Further preferably, the polymerizable monomer for forming the slurry polymer further comprises: a non-acid functional and ethylenically unsaturated polar monomer having a weight percentage content of less than or equal to 45%, wherein the non-acid functional and ethylenically unsaturated polar monomer is different from the non-tertiary alcohol (meth)acrylate monomer; and/or a vinyl monomer having a weight percentage content of less than or equal to 5%, wherein the vinyl monomer is different from the non-tertiary alcohol (meth)acrylate monomer, the acid-functional non-ester unsaturated monomer having at least one olefinic bond, and the non-acid functional and ethylenically unsaturated polar monomer.

Further preferably, in the polymerizable monomers for forming the slurry polymer, polymerizable monomers that have been copolymerized to form the (meth)acrylate copolymer have a weight percentage content of between 1% and 30%; and the viscosity of the slurry polymer at 22° C. is between 500 centipoise and 10000 centipoise.

Further preferably, a weight ratio of the elastomer to a total weight of the monomer component and the polymerizable monomer for forming the (meth)acrylate copolymer is between 0.1% and 55%.

Further preferably, a weight ratio of the elastomer to a total weight of the monomer component and the polymerizable monomer for forming the (meth)acrylate copolymer is between 0.5% and 30%.

Further preferably, a weight ratio of the elastomer to a total weight of the monomer component and the polymerizable monomer for forming the (meth)acrylate copolymer is between 0.5% and 20%.

Preferably, the monomer component further comprises: a non-acid functional and ethylenically unsaturated polar monomer, wherein the non-acid functional and ethylenically unsaturated polar monomer is different from the non-tertiary alcohol (meth)acrylate monomer; and/or a vinyl monomer, wherein the vinyl monomer is different from the non-tertiary alcohol (meth)acrylate monomer, the acid-functional non-ester unsaturated monomer having at least one olefinic bond, and the non-acid functional and ethylenically unsaturated polar monomer.

Preferably, the curable composition further comprises a photoinitiator; and/or a crosslinker.

Preferably, the curable composition further comprises any one or more of the following components: tackifying resins; black pigments; expanded polymer microspheres.

An embodiment of the present invention further provides a pressure sensitive adhesive, formed by curing a curable composition, wherein the curable composition comprises:

monomer components, comprising at least two polymerizable monomers, wherein the polymerizable monomers comprise non-tertiary alcohol (meth)acrylate monomers, and acid-functional non-ester unsaturated monomers having at least one olefinic bond; and
at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

An embodiment of the present invention further provides an adhesive tape comprising a pressure sensitive adhesive formed by curing a curable composition, wherein the curable composition comprises:

monomer components, comprising at least two polymerizable monomers, wherein the polymerizable monomers comprise non-tertiary alcohol (meth)acrylate monomers, and acid-functional non-ester unsaturated monomers having at least one olefinic bond; and
at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

Preferably, the adhesive tape comprises a backing and the pressure sensitive adhesive being provided on at least one side of the backing; or the adhesive tape comprises a backing formed with the pressure sensitive adhesive.

An embodiment of the present invention further provides an adhesive product, comprising a first member, wherein at least a partial surface of the first member has a pressure sensitive adhesive bonded thereon, and the pressure sensitive adhesive is formed by curing a curable composition, wherein the curable composition comprises:

monomer components, comprising at least two polymerizable monomers, wherein the polymerizable monomers comprise non-tertiary alcohol (meth)acrylate monomers, and acid-functional non-ester unsaturated monomers having at least one olefinic bond; and
at least one block copolymer, belonging to elastomers and comprising at least two blocks A located respectively on both ends and at least one block B located in the middle, wherein the block A is formed via polymerization of methacrylate monomers, and the block B is formed via polymerization of acrylate monomers.

Preferably, the adhesive product further comprises a second member bonded together with the first member through the above pressure sensitive adhesive.

Further preferably, the above adhesive product is any one of a mobile terminal, a tablet computer, and a notebook computer; the first member is a casing; and the second member is a display panel.

### Specific Embodiments

The present invention is exemplarily illustrated by using different formulations and parameters to prepare different curable compositions, pressure sensitive adhesives, and adhesive tapes as embodiments and comparative examples.

### 1. MATERIALS

Materials actually used in various comparative examples and embodiments of the present invention are shown in the following table:

TABLE 1

| | | | |
|---|---|---|---|
| | | Ingredients and | |
| Name | Category | relevant parameters | Purchase source |

Part 1. Materials used in various embodiments

| | | | |
|---|---|---|---|
| 2-EHA (2-Ethylhexyl | Non-tertiary alcohol | 2-Ethylhexyl | Huayi Acrylic Acid |
| Acrylate) | (meth)acrylate | acrylate | Co. Ltd., Shanghai |
| | monomer | | City, China |
| BA (Butyl Acrylate) | | Butyl acrylate | Huayi Acrylic Acid |
| | | | Co. Ltd., Shanghai |
| | | | City, China |
| IBxA (Isobornyl | High-Tg non-tertiary | Isobornyl acrylate | Osaka Organic |
| Acrylate) | alcohol (meth)acrylate | | Chemical |
| | monomer | | Corporation, Osaha, |
| | | | Japan |
| AA (Acrylic Acid) | Acid-functional non- | Acrylic acid | Huayi Acrylic Acid |
| | ester unsaturated | | Co. Ltd., Shanghai |
| | monomer having at | | City, China |
| | least one olefinic bond | | |
| NNDMAA (N,N- | Non-acid functional | N,N- | BRL Chemicals Co. |
| Dimethylacrylamide) | and ethylenically | dimethylacrylamide | Ltd., Beijing, China |
| | unsaturated polar | | |
| | monomer | | |
| α-MS (α- | Vinyl monomer | α-methyl styrene | Sinopharm Chemical |
| Methylstyrene) | | | Reagent Co. Ltd., |
| | | | Shanghai, China |
| DPHA | Polyfunctional | Dipentaerythritol | Sartomer Corporation, |
| (Dipentaerythritol | (meth)acrylate | hexaacrylate | Pennsylvania State, |
| Hexaacrylate) | crosslinker | | U.S.A. |
| HDDA (1,6- | | 1,6-Hexanediol | Cytec Corporation, |
| Hexanediol | | diacrylate | New Jersey, U.S.A. |
| diacrylate) | | | |
| FN-80SDE | Expanded polymer | Particle diameter: | Matsumoto Yushi |
| | microsphere | 20-40 μm | Seiyaku Co. Ltd., |
| | | | Osaha City, Japan |
| 461DE20d70 | | Particle diameter: | Akzonobel Pulp and |
| | | 15-25 μm | Surface Chemicals |
| 461DET80d25 | | Particle diameter: | Corporation, |
| | | 60-90 μm | Sundsvall City, |
| | | | Sweden |
| IRGACURE 651 | Photoinitiator | 2,2-dimethoxy-2- | BSF Corporation, |
| | | phenyl-1- | New Jersey, U.S.A. |
| | | acetophenone | |
| REGRELTZ 6108 | Tackifying resin | Hydrocarbon resin- | Eastman Chemical |
| | | type tackifying | Corporation, |
| | | resin | Tennessee State, |
| | | | U.S.A. |
| FORAL 85LB | | Hydrogenated rosin | Pinova Corporation, |
| | | tackifying resin | Georgia State, U.S.A. |
| UH115 | | Hydrogenated | Yasuhara Chemical |
| | | terpene phenolic | Corporation, |
| | | aldehyde tackifying | Hiroshima City, Japan |
| | | resin | |
| 9B117 | Black pigment | Black pigment | Penn Color |
| | | | Corporation, |
| | | | Pennsylvania State, |
| | | | U.S.A. |

Part 2. Materials used in various embodiments

| | | | |
|---|---|---|---|
| LA1114 | Tri-block | Weight average molecular weight: 50000 Da, | Japan Kuraray |
| | copolymer | where poly(methyl methacrylate) has a | Co. Ltd., Tokyo, |
| | (elastomer) | percentage by weight of 7% | Japan |
| LA2140 | of | Weight average molecular weight: 80000 Da, | |
| | poly(methyl | where poly(methyl methacrylate) has a | |
| | methacrylate)- | percentage by weight of 23% | |
| LA2250 | poly(n-butyl | Weight average molecular weight: 40000 Da, | |
| | acrylate)- | where poly(methyl methacrylate) has a | |
| | poly(methyl | percentage by weight of 30% | |
| LA2330 | methacrylate) | Weight average molecular weight: 120000 Da, | |
| | | where poly(methyl methacrylate) has a | |
| | | percentage by weight of 23% | |
| D1101K | Styrene block | Styrene-butadiene-styrene tri-block copolymer | Kraton |
| D1161K | copolymer | Styrene-isoprene-styrene tri-block copolymer | Performance |
| G1652 | (elastomer) | Styrene-ethylene-butadiene-styrene block | Polymers |
| | | copolymer | Corporation, |
| G1657 | | Styrene-ethylene-butadiene-styrene block | Texas State, U.S. |
| | | copolymer | |

### 2. TESTING METHOD

Some tests are performed on curable compositions, pressure sensitive adhesives, adhesive tapes and the like of various comparative examples and embodiments to determine their performance; the specific testing methods include:

### 1) Monomer Conversion Test

The monomer conversion of the slurry polymer is tested by a weight loss method, specifically including: weighing a given weight of an analyte into an aluminum plate, baking for 60±30 min in a forced convection oven at 105±3° C. to evaporate the unpolymerized polymerizable monomer, remove the remainder and cooling for 5 min followed by weighing, and calculating the monomer conversion according to the following formula:

Conversion %=100×(M1−M2)/M1,

where M1 is the total weight of the analyte before baking, M2 is the total weight of the analyte (remainder) after baking, and neither M1 nor M2 includes the weight of the aluminum plate.

### 2) Test of Weight Average Molecular Weight

The specific testing method of weight average molecular weight includes: weighing 0.1 g of the sample into a 5 ml sample flask, and dissolving it by adding therein 3 ml of tetrahydrofuran (TEDIA Co., Ltd., Ohio State, U.S.A.); filtering the solution through a filter membrane with a pore diameter of 0.45 μm followed by addition the solution into a sample flask; and performing the test with a chromatography analyzer (Waters Corporation, Maryland State, U.S.A.), calibrating the resulting chromatographic column using standard polystyrene of a known weight average molecular weight and establishing a calibration curve with the linear least squares analysis, to finally obtain the weight average molecular weight.

### 3) Test of Drop Protection Performance

The test of drop protection performance includes the following steps:

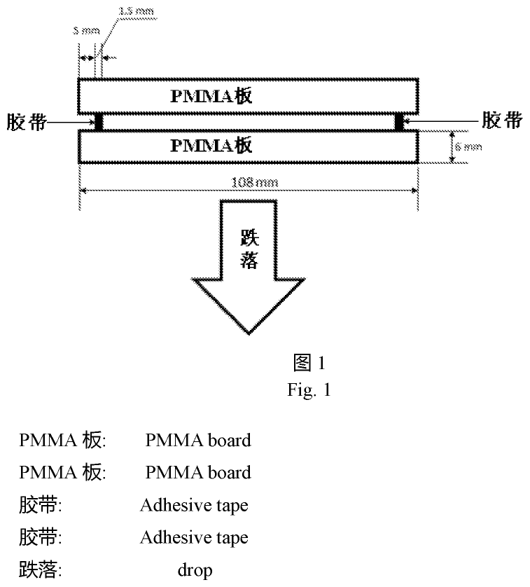

(1) Sample preparation: take two polymethyl methacrylate (PMMA) boards (hereafter referred to as PMMA boards) of a size of 108 mm*57 mm*6 mm and a weight of 38 g; the PMMA boards are wiped 3 times with isopropanol (commercially available from Sinopharm Chemical Reagent Co. Ltd., Shanghai City, China) and ensure that the solvent is completely volatilized; two strips of 1.5 mm*150 mm adhesive tapes are cut off carefully with a cutting knife from the to-be-tested adhesive tapes; the release paper on one side thereof is torn off; the two strips are respectively attached to a position 5 mm from both edges of the PMMA board along a direction parallel to the width of the PMMA board and are pressed carefully with a rubber roller to avoid bubbles between the adhesive faces; and excess portions of the adhesive tape are cut off; the release paper on the other side of the two strips of the adhesive tape is torn off; take another PMMA board is; and four edges of each of the two PMMA boards are aligned and attached together by the two strips of the adhesive tape; a heavy block weighing 4 kg (of the same area as the PMMA board) is placed on the PMMA board for 30 s; and stand the sample in the conditions of the temperature being 23±2° C. and the relative humidity being 50±5% for 24 h to obtain the sample as shown in FIG. 1 for testing.
(2) Test: place the sample in a manner parallel to the floor as is the case with the PMMA boards; then drop the sample from a height of 2 m to the cement floor; and repeat the above process (without distinguishing the side that faces downward each time), until the two PMMA boards are thoroughly separated from each other; record the number of the drops at the time the separation occurs (each adhesive tape sample is tested three times and the results are averaged), and record the separation modes. In the separation modes, PO represents that the adhesive tape is separated from the PMMA board; FS represents that the middle of the backing (foam) layer of the adhesive tape is separated; NT represents that the test cannot be performed; and N/A represents that no corresponding result is obtained; if no separation occurs after 100 drops, terminate the test; the separation number is recorded as 100; and the separation mode is recorded as N/A.

### 3. SPECIFIC PREPARATION METHOD OF SLURRY POLYMER

A slurry polymer is one of the components in a curable composition. The slurry polymer is prepared according to the following method and serves as a raw material of the curable composition. The specific preparation method of the slurry polymer includes: monomers of the types and weights as listed in the following table are fed into a 1 quart glass jar; and a photoinitiator IRGACURE 651 is added therein in an amount of 0.04 part by weight at this time based on 100 parts by weight of the polymerizable monomer for forming the slurry polymer (an additional portion of the photoinitiator is added directly into the curable composition later); nitrogen is charged into the raw material for 15 min with magnetic stirring; and then the material is exposed to irradiation from a low-intensity UV source (with a wavelength of 365 nm, and an intensity of 1.5 milliwatt/square centimeter) and continuously testing its viscosity until the slurry polymers S1-S5 with a viscosity of 500 centipoise to 7000 centipoise at room temperature are obtained.

TABLE 2
Raw materials (all used in amounts of parts by
weight) and weight average molecular weight (Da)
of polymerizable monomers of slurry polymer

| | | | | | | | Weight |
|---|---|---|---|---|---|---|---|
| | | | | | | | average |
| | | | | | | | molecular |
| Code | 2-EHA | BA | NNDMAA | IBxA | AA | α-MS | weight |
| S1 | 96 | None | None | None | 4 | None | 1798000 |
| S2 | 90 | None | None | None | 10 | None | 4256000 |
| S3 | 87.5 | None | None | None | 12.5 | None | 6525000 |
| S4 | 64.5 | None | 35 | None | 0.5 | None | 2783000 |
| S5 | 49 | 32 | None | 12 | 6.5 | 0.5 | 1162000 |

For the sake of having compatible results, the total amounts of monomer raw materials of each slurry polymer are all taken as 100 parts by weight; and slurry polymers selected in the subsequent embodiments and comparative examples are all prepared with 100 parts by weight of polymerizable monomers; and the amounts of other substances used are all based on this standard.

### 4. EMBODIMENTS AND COMPARATIVE EXAMPLES

Curable compositions of various embodiments and comparative examples were prepared below according to different formulae and pressure sensitive adhesives and adhesive tapes were formed for performance testing.

### 1) Comparative Examples C1 to C6 and Embodiments 1 to 14

S1 slurry polymer formed of 100 parts by weight of the polymerizable monomer was added into a 1 quart glass jar; then other raw materials were added therein according to the following table; and the mixture was stirred while being protected from light until uniform dissolution; and the curable compositions of comparative examples C1 to C5 and embodiments 1 to 14 were formed. The photoinitiator IRGACURE 651 in the table refers to the photoinitiator added directly into the curable composition, which together with the above photoinitiator (0.04 part by weight) that was added into the slurry polymer raw material formed the ingredients for the above photoinitiator; and the photoinitiator in the following other embodiments is the same as the one described here.

TABLE 3
Compositions of curable compositions of comparative examples C1 to C5 and embodiments 1 to 14 (amounts in parts by weight)

| | IRGACURE | | | | | | | | | | | FORAL | REGRELTZ |
|---|---|---|---|---|---|---|---|---|---|---|---|---|---|
| Code | 651 | HDDA | 9B117 | LA1114 | LA2140 | LA2250 | D1101K | G1652 | G1657 | 461DET70 | UH115 | 85LB | 6108 |
| C1 | 0.3 | 0.26 | 2 | None | None | None | None | None | None | None | None | None | None |
| C2 | 0.3 | 0.28 | 2 | None | None | None | None | None | None | None | 20 | None | None |
| C3 | 0.3 | 0.36 | 2.4 | None | None | None | 20 | None | None | None | None | None | None |
| C4 | 0.3 | 0.36 | 2.4 | None | None | None | None | 20 | None | None | None | None | None |
| C5* | 0.3 | 0.36 | 2.4 | None | None | None | None | None | 20 | None | None | None | None |
| 1 | 0.3 | 0.36 | 2.4 | 20 | None | None | None | None | None | None | None | None | None |
| 2 | 0.3 | 0.26 | 2.4 | None | 20 | None | None | None | None | None | None | None | None |
| 3 | 0.3 | 0.20 | 2.0 | None | 0.5 | None | None | None | None | None | None | None | None |
| 4 | 0.3 | 0.20 | 2.0 | None | 1 | None | None | None | None | None | None | None | None |
| 5 | 0.3 | 0.26 | 2.1 | None | 5 | None | None | None | None | None | None | None | None |
| 6* | 0.3 | 0.40 | 2.6 | None | 40 | None | None | None | None | None | None | None | None |
| 7 | 0.3 | 0.32 | 2.4 | None | 20 | None | None | None | None | 1.2 | None | None | None |
| 8 | 0.3 | 0.32 | 2.4 | None | 20 | None | None | None | None | 4 | None | None | None |
| 9 | 0.4 | 0.52 | 6.5 | None | 20 | None | None | None | None | 1.2 | None | None | None |
| 10 | 0.3 | 0.36 | 2.4 | None | 20 | None | None | None | None | 1.2 | 12 | None | None |
| 11 | 0.3 | 0.36 | 2.4 | None | 20 | None | None | None | None | 0.6 | 24 | None | None |
| 12 | 0.3 | 0.36 | 2.4 | None | 20 | None | None | None | None | 1.2 | None | 12 | None |
| 13 | 0.3 | 0.36 | 2.4 | None | 20 | None | None | None | None | 1.2 | None | None | 12 |
| 14 | 0.3 | 0.36 | 2.4 | 10 | None | 10 | None | None | None | None | None | None | None |

The curable compositions of the above various embodiments were applied between the release surfaces of two CP Film T10 PET transparent release films having a thickness of 0.05 mm (commercially available from Solutia Corporation, Tennessee State, U.S.A.), and a thickness of the adhesive film being controlled at 0.15 mm; and irradiated for 5 min to 10 min under the above low-intensity UV light (365 nm, 1.5 milliwatt/square centimeter) to obtain an adhesive film. In order to improve the operating performance of the pressure sensitive adhesive tape, when the curable compositions of comparative examples C1 to C4 and embodiments 1 to 9 were applied, a layer of Cerex23030 nylon fabric (Cerex High Performance Fiber Co., Ltd., Florida State, U.S.A.) was added to serve as a backing.

Both sides of the above adhesive film were each coated with a layer of primer which was a solution containing 10% by weight of a solute; the solute is Macromelt 6240 (Henkel Corporation, Dusseldorf, Germany), and the solvent comprises: 47.5 parts by weight of isopropanol (Sinopharm Chemical Reagent Co. Ltd., Shanghai, China), 47.5 parts by weight of n-propanol (Sinopharm Chemical Reagent Co. Ltd., Shanghai, China), and 5 parts by weight of water. After 10 min of drying at 80° C., a prime coat of a thickness of 5 μm to 10 μm could be obtained. The conventional pressure sensitive adhesive tapes 9482PC (3M Corporation, Minnesota State, U.S.A.) with a thickness of 0.05 mm were respectively applied on the prime coats at both sides; and pressed by hand with a 2-kg rubber roller to obtain a double-faced adhesive tape with a total thickness of 0.25 mm.

In other words, the adhesive tape prepared as above mainly comprised two different structures: in the first structure (comparative examples C1 to C4 and embodiments 1 to 9), the pressure sensitive adhesive of the present invention and an existing adhesive (pressure sensitive adhesive tape 9482PC) were successively provided on a nylon backing (Cerex23030); and in the second structure (comparative example C5 and embodiments 10 to 14), an existing adhesive (pressure sensitive adhesive tape 9482PC) were provided on a backing of the pressure sensitive adhesive of the present invention.

In addition, regarding the pressure sensitive adhesive of embodiment 2, a sample was further prepared without the pressure sensitive adhesive tape 9482PC provided thereon (and certainly without the primer provided), namely, a nylon backing provided only with the pressure sensitive adhesive of the present invention (recorded as a “mono-adhesive layer”).

In addition, regarding the pressure sensitive adhesive of embodiment 2, a sample was further prepared without the pressure sensitive adhesive tape 9482PC and the nylon backing provided thereon (and certainly without the primer provided), namely, it was simply an adhesive film of the pressure sensitive adhesive of the present invention (recorded as an “adhesive layer”).

In addition, regarding the pressure sensitive adhesive of embodiment 7, a sample that further prepared with the pressure sensitive adhesive tape 9482PC being provided only on one side (and certainly the primer is provided on that side) (recorded as “single-sided adhesive”); that is, the surface on the other side thereof was the pressure sensitive adhesive of the present invention.

In addition, regarding the pressure sensitive adhesive of embodiment 7, a sample was further prepared without the pressure sensitive adhesive tape 9482PC and the nylon backing provided thereon (and certainly without the primer provided), namely, it was simply an adhesive film of the pressure sensitive adhesive of the present invention (recorded as an “adhesive layer”).

Moreover, comparative example C6 was further added, comprising: applying pressure sensitive adhesive tapes 9482PC onto both sides of a black polyethylene (PE) foam having a thickness of 0.15 mm (Hubei Xiangyuan New Material Technology Co. Ltd., Xiaogan City, Hubei Province, China); before the two were adhered, both were subject to corona treatment (Softal Corona Machine, Hamburg, Germany) on both sides so that a surface energy would be greater than 52 dyne/cm; and pressed by hand with a 2-kg rubber roller to ensure a complete attachment between the adhesive film and polyethylene foam.

After the above various samples were stood in the conditions of the temperature being at 23±2° C. and the relative humidity being 50±5% for 24 h, they were tested for the drop protection performance. The results are shown in the following table:

TABLE 4
Test results of drop protection performance of
comparative examples C1 to C6 and embodiments 1 to 14

| Code | Separation number | Separation mode |
|---|---|---|
| C1 | 16 | PO |
| C2 | 15 | PO |
| C3 | 12 | PO |
| C4 | 39 | PO |
| C5 | NT | N/A |
| C6 | 4 | FS |
| 1 | 52 | PO |
| 2 | 82 | PO |
| 2 (Mono-adhesive layer) | 83 | PO |
| 2 (Adhesive Film) | 83 | PO |
| 3 | 100 | N/A |
| 4 | 100 | N/A |
| 5 | 100 | N/A |
| 6 | NT | N/A |
| 7 | 100 | N/A |
| 7 (Single-sided adhesive) | 100 | N/A |
| 7 (Adhesive Film) | 100 | N/A |
| 8 | 83 | PO |
| 9 | 100 | N/A |
| 10 | 100 | N/A |
| 11 | 100 | N/A |
| 12 | 100 | N/A |
| 13 | 100 | N/A |
| 14 | 63 | PO |

In the curable compositions of comparative example C5 and embodiment 6, the block copolymer (elastomer) could not be completely dissolved in the end; no uniform product could be formed, and therefore it was not tested for the performance.

The results show that as compared with comparative examples C1 to C2 that did not have a block copolymer added therein, comparative examples C3 to C5 with conventional styrene block copolymers added therein, and comparative example C6 that used polyethylene foam and the like, pressure sensitive adhesives of various embodiments of the present invention all had significantly improved drop protection performance, with no separation occurred even after the samples were dropped to 100 times.

### 2) Comparative Examples C7 and C8 and Embodiments 15 and 16

S2 slurry polymer formed of 100 parts by weight of the polymerizable monomer was added into a 1 quart glass jar; then other raw materials were added therein according to the following table; and the mixture was stirred while being protected from light until uniform dissolution; and the curable compositions of comparative examples C7 and embodiments 15 and 16 were formed.

TABLE 5
Compositions of curable compositions of comparative
example C7 and embodiments 15 and 16 (amounts in
parts by weight)

| Code | IRGACURE 651 | HDDA | 9B117 | LA2250 |
|---|---|---|---|---|
| C7 | 0.3 | 0.24 | 1.1 | None |
| 15 | 0.3 | 0.4 | 2 | 40 |
| 16* | 0.3 | 0.4 | 2 | 50 |

The curable compositions were applied between the release surfaces of two CP Film T10 PET transparent release films having a thickness of 0.05 mm, and a thickness of the adhesive film being controlled at 0.1 mm; and irradiated for 5 min to 10 min under the low-intensity UV light mentioned above to obtain an adhesive film.

A layer of primer coat was formed on each side of the adhesive film according to the above method. The conventional pressure sensitive adhesive tapes 9458 (3M Corporation, Minnesota State, U.S.A.) with a thickness of 0.025 mm were respectively applied on the prime coats at both sides; and pressed by hand with a 2-kg rubber roller to obtain a double-faced adhesive tape with a total thickness of 0.15 mm.

Moreover, comparative example C8 was further added, comprising: performing a corona treatment on a black polyethylene foam having a thickness of 0.1 mm (Hubei Xiangyuan New Material Technology Co., Ltd., Xiaogan City, Hubei Province, China) by following the method described above; afterwards, applying the pressure sensitive adhesive tapes 9458 onto both sides of the polyethylene foam.

After the above various samples were stood in the conditions of the temperature being at 23±2° C. and the relative humidity being 50±5% for 24 h, they were tested for the drop protection performance. The results are shown in the following table:

TABLE 6
Test results of drop protection performance for
comparative examples C7 and C8 and embodiments 15 and 16

| Code | Separation number | Separation mode |
|---|---|---|
| C7 | 2 | PO |
| C8 | 2 | FS |
| 15 | 13 | PO |
| 16* | NT | N/A |

In the curable compositions of embodiment 16, the block copolymer (elastomer) could not be completely dissolved in the end; no uniform product could be formed, and therefore it was not tested for the performance.

The above results indicate that after the addition of the specific block copolymer (elastomer) of the present invention, the drop protection performance of the pressure sensitive adhesive can be significantly improved.

### 3) Comparative Example C9 and Embodiments 17 and 18

S3 slurry polymer formed of 100 parts by weight of the polymerizable monomer was added into a 1 quart glass jar; then other raw materials were added therein according to the following table; and the mixture was stirred while being protected from light until uniform dissolution; and the curable compositions of comparative example C9 and embodiments 17 and 18 were formed.

TABLE 7
Compositions of curable compositions of comparative
example C9 and embodiments 17 and 18 (amounts in
parts by weight)

| Code | IRGACURE 651 | HDDA | 9B117 | LA1114 |
|---|---|---|---|---|
| C9 | 0.24 | 0.24 | 1.5 | None |
| 17 | 0.24 | 0.24 | 1.7 | 14 |
| 18 | 0.24 | 0.35 | 1.8 | 24 |

The curable compositions were applied between the release surfaces of two CP Film T10 PET transparent release films having a thickness of 0.05 mm, and a thickness of the adhesive film being controlled at 0.2 mm; and irradiated for 5 min to 10 min under the low-intensity UV light mentioned above to obtain an adhesive film.

A layer of primer coat was formed on each side of the adhesive film according to the above method. The conventional pressure sensitive adhesive tapes 467MP (3M Corporation, Minnesota State, U.S.A.) with a thickness of 0.05 mm were respectively applied on the prime coats at both sides; and pressed by hand with a 2-kg rubber roller to obtain a double-faced adhesive tape with a total thickness of 0.3 mm.

After the above various samples were stood in the conditions of the temperature being at 23±2° C. and the relative humidity being 50±5% for 24 h, they were tested for the drop protection performance. The results are shown in the following table:

TABLE 8
Test results of drop protection performance for
comparative example C9 and embodiments 17 and 18

| Code | Separation number | Separation mode |
|---|---|---|
| C9 | 1 | PO |
| 17 | 3 | PO |
| 18 | 13 | PO |

The above results indicate that after the addition of the specific block copolymer (elastomer) of the present invention, the drop protection performance of the pressure sensitive adhesive can be significantly improved.

### 4) Comparative Example C10 and Embodiments 19 to 22

S4 slurry polymer formed of 100 parts by weight of the polymerizable monomer was added into a 1 quart glass jar; then other raw materials were added therein according to the following table; and the mixture was stirred while being protected from light until uniform dissolution; and the curable compositions of comparative example C10 and embodiments 19 to 22 were formed.

TABLE 9
Compositions of curable compositions of comparative
example C9 and embodiments 21 to 24 (amounts in
parts by weight)

| Code | IRGACURE 651 | HDDA | 9B117 | LA2250 | FN-80SDE |
|---|---|---|---|---|---|
| C10 | 0.24 | 0.1 | 2.5 | None | None |
| 19 | 0.3 | 0.15 | 2.8 | 24 | None |
| 20 | 0.3 | 0.22 | 3.5 | 48 | 9 |
| 21 | 0.3 | 0.3 | 4 | 54 | 10 |
| 22* | 0.3 | 0.34 | 4.3 | 60 | 11 |

The curable compositions were applied between the release surfaces of two CP Film T10 PET transparent release films having a thickness of 0.05 mm, and a thickness of the adhesive film being controlled at 0.25 mm; and irradiated for 5 min to 10 min under the low-intensity UV light mentioned above to obtain an adhesive film.

A layer of primer coat was formed on each side of the adhesive film according to the above method. The conventional pressure sensitive adhesive tapes 467MP (3M Corporation, Minnesota State, U.S.A.) with a thickness of 0.05 mm were respectively applied on the prime coats at both sides; and pressed by hand with a 2-kg rubber roller to obtain a double-faced adhesive tape with a total thickness of 0.35 mm.

After the above various samples were stood in the conditions of the temperature being at 23±2° C. and the relative humidity being 50±5% for 24 h, they were tested for the drop protection performance. The results are shown in the following table:

TABLE 10
Test results of drop protection performance for
comparative example C10 and embodiments 19 to 22

| Code | Separation number | Separation mode |
|---|---|---|
| C10 | 1 | PO |
| 19 | 3 | PO |
| 20 | 4 | PO |
| 21 | 16 | PO |
| 22 | NT | N/A |

In the curable compositions of embodiment 22, the block copolymer (elastomer) could not be completely dissolved in the end; no uniform product could be formed, and therefore it was not tested for the performance.

The above results indicate that after the addition of the specific block copolymer (elastomer) of the present invention, the drop protection performance of the pressure sensitive adhesive can be significantly improved.

### 5) Comparative Examples C11 and 12 and Embodiments 23 and 24

S5 slurry polymer formed of 100 parts by weight of the polymerizable monomer was added into a 1 quart glass jar; then other raw materials were added therein according to the following table; and the mixture was stirred while being protected from light until uniform dissolution; and the curable compositions of comparative examples C11 and 12 and embodiments 23 and 24 were formed.

TABLE 11
Compositions of curable compositions of comparative examples C11
and C12 and embodiments 23 and 24 (amounts in parts by weight)

| Code | IRGACURE 651 | DPHA | 9B117 | D1161K | LA2140 | LA2250 | 461DET80d25 |
|---|---|---|---|---|---|---|---|
| C11 | 0.24 | 0.38 | 5 | None | None | None | 5 |
| C12 | 0.24 | 0.38 | 5.3 | 12 | None | None | 5 |
| 23 | 0.24 | 0.38 | 5.3 | None | 6 | 6 | 5 |
| 24 | 0.24 | 0.38 | 5.3 | None | 6 | 6 | 7 |

The curable compositions were applied between the release surfaces of two CP Film T10 PET transparent release films having a thickness of 0.05 mm, and a thickness of the adhesive film being controlled at 0.3 mm; and irradiated for 5 min to 10 min under the low-intensity UV light mentioned above to obtain an adhesive film.

A layer of primer coat was formed on each side of the adhesive film according to the above method. The conventional pressure sensitive adhesive tapes 467MP and 9482PC (3M Corporation, Minnesota State, U.S.A.) with a thickness of 0.05 mm were respectively applied on the prime coats at both sides; and pressed by hand with a 2-kg rubber roller to obtain a double-faced adhesive tape with a total thickness of 0.4 mm.

After the above various samples were stood in the conditions of the temperature being at 23±2° C. and the relative humidity being 50±5% for 24 h, they were tested for the drop protection performance. The results are shown in the following table:

TABLE 12
Test results of drop protection performance for
comparative examples C11 and C12 and embodiments 23 and 24

| Code | Separation number | Separation mode |
|---|---|---|
| C11 | 3 | PO |
| C12 | 5 | PO |
| 23 | 28 | PO |
| 24 | 32 | PO |

The above results indicate that after the addition of the specific block copolymer (elastomer) of the present invention, the drop protection performance of the pressure sensitive adhesive can be significantly improved.

### CONCLUSIONS

The following conclusions are made based on the performance tests for the above various embodiments and comparative examples:

(1) The addition of one or more specific block copolymers (elastomers) of the present invention into an acrylate pressure sensitive adhesive can significantly improve the drop protection performance of the pressure sensitive adhesive.
(2) Under the same condition, the drop protection performance of the various comparative examples that use other conventional block copolymers (elastomers) is still far lower than the embodiments that use the specific block copolymers (elastomers) of the present invention. This indicates that not every block copolymer (elastomer) would be able to improve the drop protection performance of a pressure sensitive adhesive. Possible reasons that the specific block copolymer (elastomer) of the present invention can improve the drop protection performance are: the block copolymer has good elasticity and can be greatly integrated with other components in the acrylate pressure sensitive adhesive; thus after the specific block copolymer is added, the specific block copolymer can absorb a great deal of the drop impact, which in turn minimizes the impact from which other part of the casing might be suffering and thus improves the drop performance of the pressure sensitive adhesive. The above analysis should not be construed as limiting the action principle of the present invention.
(3) Regardless of what other optional components (e.g., tackifying resins, black pigments, expanded polymer microspheres, vinyl monomers, and non-acid functional and ethylenically unsaturated polar monomers) of the acrylate pressure sensitive adhesive are, the use of the specific block copolymer (elastomer) of the present invention will always improve the drop protection performance of the pressure sensitive adhesive.
(4) Regardless of the forms (e.g., a separate adhesive film or foam, a backing of an adhesive tape, an adhesive on a backing of an adhesive tape, a single-faced adhesive or a double-faced adhesive, used alone or in combination with other know adhesives) of the pressure sensitive adhesive, the pressure sensitive adhesive improves the drop protection performance.
(5) In some curable compositions with a too high content of a block copolymer (elastomer), the block copolymer could not be dissolved completely, and therefore a uniform product was not produced. This indicates that, a specific content of a block copolymer (elastomer) in a curable composition is required; and the content should not be too high; and the upper value of the content is also related to other components.
(6) Better drop protection performance was obtained in various embodiments on the whole where the slurry polymer S1 is used. This indicates that it is relatively preferable for a raw material of a slurry polymer to have a high content of a non-tertiary alcohol (meth)acrylate monomer (e.g., 95% to 99.5%) and a low content of an acid-functional non-ester unsaturated monomer having at least one olefinic bond (e.g., 0.5% to 5%). This is possibly because such a pressure sensitive adhesive has a lower hardness (or a lower glass transition temperature) on the whole, and thus is “softer” and can better absorb the drop impact under the same condition.
(7) Although other performance of the pressure sensitive adhesive is not tested herein, the fact that the pressure sensitive adhesive could bond two PMMA boards firmly together and the boards could undergo multiple drops suggests that the bonding power is not too bad. At the same time, regarding embodiments where the separation occur, these samples all have the PO separation mode, rather than the FS separation mode (FS separation mode only occurs in the comparative examples), which indicates that the cohesive strength of the pressure sensitive adhesive itself is quite strong. As a result, the pressure sensitive adhesive of the present invention would at least be able to meet the basic requirement regarding other conventional performance thereof.

It can be understood that, the above embodiments are only exemplary embodiments employed for illustration of principles of the present invention, and do not limit the present invention. For those of ordinary skill in the art, various variations and modifications may be made without departing from the spirit and essence of the present invention, which variations and modifications are also considered as falling within the protection scope of the present invention.

1. A curable composition, comprising:
a monomer component comprising at least two polymerizable monomers which include a (meth)acrylate monomer of non-tertiary alcohol, and an acid functionalized non-ester unsaturated monomer having at least one olefinic bond; and
at least a block copolymer belonging to elastomer which comprises at least two A blocks separately at the two ends thereof, and at least a B block in the middle thereof; wherein the A block is formed by a polymerization of methacrylate monomers, and the B block is formed by a polymerization of acrylate monomers.

2. The curable composition according to claim 1, wherein the block copolymer is a triblock copolymer having a structure of A block-B block-A block.

3. The curable composition according to claim 1, wherein the A block is formed by a polymerization of alkyl methacrylate monomers; and the B block is formed by a polymerization of alkyl acrylate monomers.

4. The curable composition according to claim 3, wherein the alkyl methacrylate monomer is a methyl methacrylate monomer; and the alkyl acrylate monomer is a n-butyl acrylate monomer.

5. The curable composition according to claim 1, wherein the block copolymer has a weight-average molecular weight between 2000 Dalton and 500000 Dalton.

6. The curable composition according to claim 1, wherein, in the block copolymer, the content of A block is 5 wt % to 50 wt %, and the content of B block is 50 wt % to 95 wt %.

7. The curable composition according to claim 1, further comprising:
a (meth)acrylate copolymer formed by a copolymerization of a raw material comprising at least two polymerizable monomers which include a (meth)acrylate monomer of non-tertiary alcohol, and an acid functionalized non-ester unsaturated monomer having at least one olefinic bond; and
the (meth)acrylate copolymer has a weight-average molecular weight between 500000 Dalton and 10000000 Dalton.

8. The curable composition according to claim 7, wherein the monomer component and the a (meth)acrylate copolymer constitute a slurry polymer; and
the slurry polymer is formed by a partial copolymerization of a raw material comprising at least two polymerizable monomers which include a (meth)acrylate monomer of non-tertiary alcohol, and an acid functionalized non-ester unsaturated monomer having at least one olefinic bond.

9. The curable composition according to claim 8, wherein, in the polymerizable monomers used to form the slurry polymer,
the content of the (meth)acrylate monomer of non-tertiary alcohol is 84 wt % to 99 wt %; and
the content of the acid functionalized non-ester unsaturated monomer having at least one olefinic bond is 1 wt % to 4 wt %.

10. The curable composition according to claim 7, wherein a weight ratio of the elastomer to the total weight of the monomer component and the polymerizable monomers used to form the (meth)acrylate is 0.1% to 55%.

11. The curable composition according to claim 10, wherein the weight ratio of the elastomer to the total weight of the monomer component and the polymerizable monomers used to form the (meth)acrylate is 0.5% to 30%.

12. The curable composition according to claim 1, further comprising:
a photoinitiator; and/or
a crosslinking agent.

13. A pressure-sensitive adhesive formed by curing a curable composition which comprises:
a monomer component comprising at least two polymerizable monomers which include a (meth)acrylate monomer of non-tertiary alcohol, and an acid functional non-ester unsaturated monomer having at least one olefinic bond; and
at least a block copolymer belonging to elastomer which comprises at least two A blocks separately at the two ends thereof, and at least a B block in the middle thereof; wherein the A block is formed by a polymerization of methacrylate monomers, and the B block is formed by a polymerization of acrylate monomers.

14. An adhesive tape comprising a pressure-sensitive adhesive formed by curing a curable composition, wherein the curable composition comprises:
a monomer component comprising at least two polymerizable monomers which include a (meth)acrylate monomer of non-tertiary alcohol, and an acid functionalized non-ester unsaturated monomer having at least one olefinic bond; and
at least a block copolymer belonging to elastomer which comprises at least two A blocks separately at the two ends thereof, and at least a B block in the middle thereof; wherein the A block is formed by a polymerization of methacrylate monomers, and the B block is formed by a polymerization of acrylate monomers.

15. (canceled)
